(19) United States
(12) Patent Application Publication
(10) Pub. No.: US 2017/0290642 A1
(43) Pub. Date: Oct. 12, 2017

(54) Teeth Adjustment Arrangement

(71) Applicant: Jiachang Zhang, Anaheim, CA (US)

(72) Inventor: Jiachang Zhang, Anaheim, CA (US)

(21) Appl. No.: 15/093,715

(22) Filed: Apr. 7, 2016

(51) Int. Cl. A61C 7/10; A61C 7/16

(52) U.S. Cl. CPC A61C 7/10; A61C 7/16

(57) ABSTRACT

A teeth adjustment arrangement includes a plurality of end retainers adapted for affixing to abutting teeth respectively; and a space expansion unit coupled between the end retainers to create an opposed expansion force against the end retainers for enlarging a corrective space between the abutting teeth corresponding to an associated tooth therebetween. Therefore, the associated tooth is adapted to concurrently move within the corrective space and align with the abutting teeth at the same time.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to orthodontic fittings, and more particular to a teeth adjustment arrangement to move and align teeth at the same time while being time effective.

### Description of Related Arts

Dental braces or orthodontic braces are tools for resetting the position of a crooked tooth to a desired configuration in a patient's mouth. In particular, the orthodontists generally place the braces to the patient's teeth and apply an adjusting force at the braces in order to move the teeth toward the desired positions. Traditional metal wired brace assembly are the most common type of braces, wherein the metal wired brace assembly comprises a plurality of metal brackets affixed to the teeth respectively and a wire extended through the metal brackets to move the teeth gradually. Alternatively, an elastic band is affixed to the metal brackets to apply the pulling force thereto.

Accordingly, in order to correct the alignment of the crooked tooth, two abutting teeth must be moved away from each other to create sufficient space for fitting the crooked tooth thereat. Once the abutting teeth are moved, the crooked tooth can then be moved between the abutting teeth in a corrected alignment.

Accordingly, the operation steps of the above mentioned orthodontics method are complicated and cannot be directly applied on crowed teeth or irregular teeth (overbite). The step of expanding the space between the abutting teeth and the step of pushing the crooked teeth into the space are two separate steps. In other words, the space must be expanded first, and then the crooked teeth can be pushed into the space, so the two steps cannot be implemented concurrently.

The common type of the orthodontics method has the following drawbacks. The size of the space between the abutting teeth is difficult to be controlled. If too much force is exerted on the abutting teeth, the space therebetween will be too large. After the crooked teeth are pushed into the space, the abutting teeth must be pushed back toward the crooked teeth to minimize the space between the teeth. It is inconvenient and time-consuming for frequently inspection and tension adjustment in order to ensure the space is sufficient for the crooked teeth. Furthermore, the orthodontics period is very long. It takes a relatively long treatment time to adjust the size of the space of the abutting teeth, and then takes additional time to push the crooked tooth into the space. The two separate steps cause a lot of pains for the patients during each inspection.

Another type of teeth brace is provided to solve the overbite problems in the orthodontics industry. Accordingly, one end of the wire is bound on the one side of the molars, and extended along all the other teeth, while the other end of the wire is bound on the other side of the molars. And, this technique can be applied on both the upper teeth and the lower teeth. However, all of the teeth including the good condition and crooked teeth are pulled by the wire, and in such a manner that the growths of the good condition teeth are interrupted and even are damaged. In other words, the technique cannot be focused on strengthening an assigned misaligned tooth.

### SUMMARY OF THE PRESENT INVENTION

A main object of the present invention is to provide a teeth adjustment device, wherein the teeth adjustment device is able to expand a corrective space between two abutting teeth corresponding to an associated tooth therebetween.

Another object of the present invention is to provide a teeth adjustment device, wherein a space expansion unit is coupled between said end retainers to create an opposed expansion force against the end retainers for enlarging the corrective space between the abutting teeth, so as to minimize the numbers of teeth to be involved in the orthodontic process.

Another object of the present invention is to provide a teeth adjustment device, wherein the associated tooth is concurrently moved toward the corrective space at the same time when the corrective space is enlarged, so as to ensure the associated tooth to be fitted at the corrective space.

Another object of the present invention is to provide a teeth adjustment device, which moves and aligns the teeth at the same time so as to reduce the treatment time for orthodontic.

Another object of the present invention is to provide a teeth adjustment device, wherein the associated tooth is moved to align with the abutting teeth by the expansion force, such that the abutting teeth and the associated tooth are correspondingly moved by the same expansion force to ensure the corrective space to precisely fit the associated tooth therewithin.

Another object of the present invention is to provide a teeth adjustment device, wherein the expansion force is guided via a space guider to ensure the direction of the expansion force toward the abutting teeth.

Another object of the present invention is to provide a teeth adjustment device, wherein different compression springs can be selectively coupled to selectively adjust the expansion force in order to achieve different levels of crooked teeth problems.

Another object of the present invention is to provide a teeth adjustment device, wherein the space expansion unit is easy to detachably affix to the teeth without disassemble an overall structure of the teeth adjustment device.

Another object of the present invention is to provide a teeth adjustment device, wherein no expansive and complicated structure are required to be employed in the present invention in order to achieve the above mentioned objects. Therefore, the present invention successfully provides an economic and efficient solution that generates the expansion force on two abutting teeth and concurrently generates a pulling force to straighten the associated tooth.

In accordance with another aspect of the invention, the present invention can be applied to straighten a plurality of associated tooth without affecting or damaging other good condition teeth to decrease painful suffered by patients.

According to the present invention, the foregoing and other objects and advantages are attained by a teeth adjustment arrangement which comprises a bracket assembly and a space expansion unit.

The bracket assembly comprises a plurality of end retainers adapted for affixing to abutting teeth respectively. The space expansion unit is coupled between the end retainers to create an opposed expansion force against the end retainers for enlarging a corrective space between the abutting teeth corresponding to an associated tooth therebetween.

In accordance with another aspect of the invention, the present invention comprises a method of resetting a position of an associated tooth between two abutting tooth to a desired configuration in a patient's mouth, comprising the following steps.

(A) Affix a plurality of end retainers to the abutting teeth respectively.

(B) Couple a space expansion unit between the end retainers to create an opposed expansion force against the end retainers for enlarging a corrective space between the abutting teeth corresponding to the associated tooth therebetween.

Additional advantages and featuring of the invention will become apparent from the description which follows, and may be realized by means of the instrumentalities and combinations particular point out in the appended claims.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a teeth adjustment arrangement according to a preferred embodiment of the present invention.

FIG. 2 is a perspective view of a space expansion unit of the teeth adjustment arrangement according to the above preferred embodiment of the present invention, illustrating the compression spring being initially compressed.

FIG. 3 is a perspective view of space expansion unit of the teeth adjustment arrangement according to the above preferred embodiment of the present invention, illustrating the compression spring being expanded to enlarge the corrective space.

FIG. 4 is a perspective view of the teeth adjustment arrangement according to the above preferred embodiment of the present invention, illustrating the associated tooth being moved to align with the abutting teeth.

FIG. 5 is a perspective view of the teeth adjustment arrangement according to the above preferred embodiment of the present invention, illustrating the teeth adjustment arrangement for two or more associated teeth.

FIG. 6 illustrates an alternative mode of the teeth adjustment arrangement according to the above preferred embodiment of the present invention, illustrating the space expansion unit to be retained via a wiring element.

### DETAILED DESCRIPTION OF THE PREFERRED EMBODIMENT

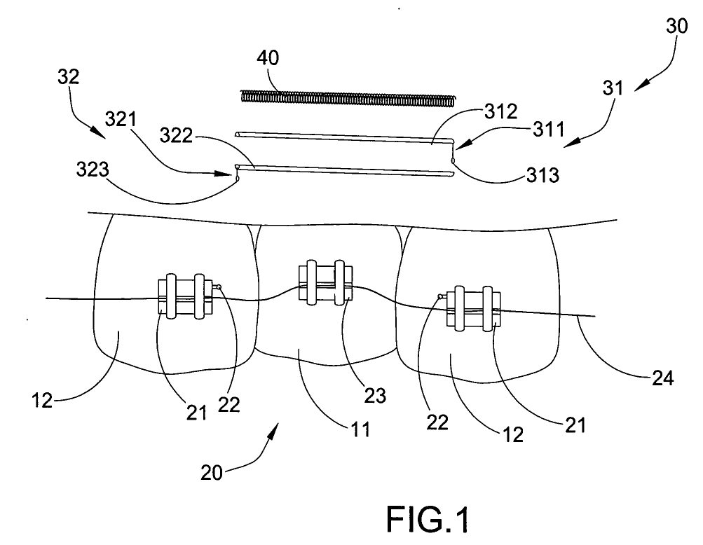

Referring to FIG. 1 of the drawings, a teeth adjustment arrangement according to a preferred embodiment of the present invention is illustrated, wherein the teeth adjustment arrangement is arranged for realigning the teeth to a desired configuration in the patient's mouth. For example, the teeth adjustment arrangement is arranged for resetting a position of an associated tooth 11 between two abutting teeth 12, wherein the associated tooth 11 is a crooked tooth that the associated tooth 11 is misaligned with the abutting teeth 12. Accordingly, the teeth adjustment arrangement comprises a bracket assembly 20 and a space expansion unit.

The bracket assembly 20 comprises a plurality of end retainers 21 adapted for affixing to the abutting teeth 12 respectively. Accordingly, the end retainers 21 are affixed to surfaces of the abutting teeth 12 respectively, wherein bonding agent is applied between the surface of the abutting tooth 12 and the backing of the end retainer 21.

The space expansion unit is coupled between the end retainers 21 to create an opposed expansion force against the end retainers 21 for enlarging a corrective space between the abutting teeth 12 corresponding to the associated tooth 11 therebetween. Accordingly, the expansion force is applied between the abutting teeth 12 in order to move the abutting teeth 12 away from each other. In other words, the distance between the end retainers 21 will be prolonged when the abutting teeth 12 are moved away from each other. As a result, the corrective space between the abutting teeth 12 will be enlarged after the abutting teeth 12 are moved away from each other by the expansion force.

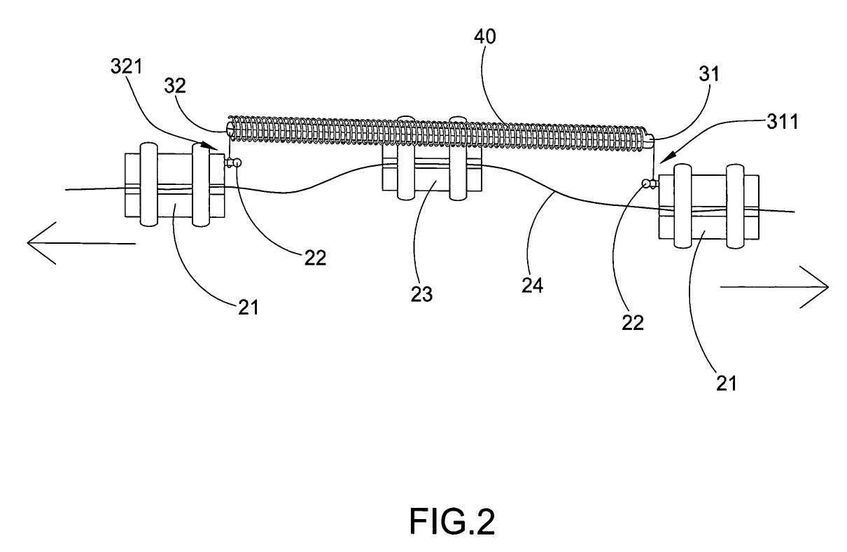

As shown in FIG. 2, the space expansion unit comprises a space guider 30 extended between the end retainers 21 to guide a direction of the expansion force, and a resilient element 40 coupled along the space guider 30 to generate the expansion force for pushing the abutting teeth 12 away from each other.

The space guider 30 has an elongated structure to retain the resilient element 40 in position in order to ensure the direction of the expansion force exerting to the abutting teeth 12. In particular, the space guider 30 comprises a first guiding shaft 31 having a first end 311 coupled at one of the abutting teeth 12, and a second guiding shaft 32 having a second end 321 coupled at another abutting tooth 12. The first and second guiding shafts 31, 32 are slidably engaged with each other to retain the resilient element 40 between the first and second ends 311, 321 so as to selectively adjust a distance between the first and second ends 311, 321 of the first and second guiding shafts 31, 32 in response to the expansion force.

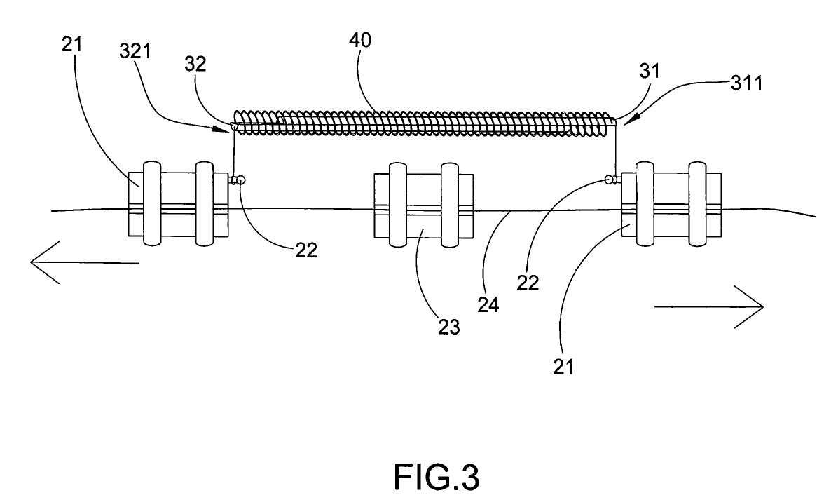

When the expansion force is applied along the first and second guiding shafts 31, 32 to exert between the end retainers 21, the first and second guiding shafts 31, 32 are slidably moved to prolong the distance between the first and second ends 311, 321 of the first and second guiding shafts 31, 32, as shown in FIG. 3. In particular, each of the first and second guiding shafts 31, 32 comprises an elongated shaft body 312, 322 and a connecting body 313, 323 extended from the shaft body 312, 322 to couple with the respective end retainer 21. In particular, the shaft bodies 312, 322 are two straight members, wherein the connecting bodies 313, 323 are transversely extended from the ends of the shaft bodies 312, 322 respectively.

According to the preferred embodiment, each of the first and second guiding shafts 31, 32 has a semi-circular cross section to form a circular member when the first and second guiding shafts 31, 32 are coupled with each other. In particular, each of the shaft bodies 312, 322, having a semi-circular cross section, has a flat sliding surface and a curved guiding surface, wherein the sliding surfaces of the shaft bodies 312, 322 are slidably coupled with each other.

The first end 311 of the first guiding shaft 31 is defined at the connecting body 313 thereof while the second end 321 of the second guiding shaft 32 is defined at the connecting body 323 thereof, wherein the connecting bodies 313, 323 are detachably coupled at the end retainers 21 respectively.

Therefore, when the resilient element 40 pushes the first and second ends 311, 321 of the first and second guiding shafts 31, 32 away from each other, the shaft bodies 312, 322 are slid at the sliding surfaces thereof in opposite directions. In other words, the distance between the first and second ends 311, 321 of the first and second guiding shafts 31, 32 is the distance between the end retainers 21. As a result, when the distance between the first and second ends 311, 321 of the first and second guiding shafts 31, 32 is gradually increased by moving the first and second guiding shafts 31, 32 at the opposite directions, the distance between the end retainers 21 will be correspondingly increased to enlarge the corrective space between the abutting teeth 12.

As shown in FIGS. 2 and 3, the resilient element 40 is a compression spring coaxially coupled along the space guider 30 for generating an expansion spring force as the expansion force to push the end retainers 21 away from each other. The resilient element 40 is made from a suitable material such as stainless steel to be impervious to the acids in the patient's body and to prevent from being corroded in the patient's mouth. Preferably, the resilient element 40 is made of shape-memory alloy which is pseudoelastic at the temperature prevailing in the patient's mouth.

In particular, the resilient element 40 is encircled around the curved guiding surfaces of the shaft bodies 312, 322, wherein the diameter of the resilient element 40 is slightly larger than a diameter of the space guider 30. Therefore, the space guider 30 not only guides the direction of the expansion force but also retain the resilient element 40 between the end retainers 21. It is worth mentioning that two ends of the resilient element 40 are biased against the connecting bodies 313, 323 of the first and second guiding shaft 31, 32 to push the first and second ends 311, 321 of the first and second guiding shaft 31, 32 away from each other. It is appreciated that the connecting bodies 313, 323 can be integrally extended from two ends of the resilient element 40 to apply the expansion force between the end retainers 21, such that the shaft bodies 312, 322 of the first and second guiding shaft 31, 32 will only guide the direction of the expansion force.

It is worth mentioning that the resilient element 40 is compressed at the initial state to gradually apply the expansion force between the end retainers 21, so as to gradually move the abutting teeth 12 away from each other to enlarge the corrective space therebetween.

As it is mentioned above, the connecting bodies 313, 323 are detachably coupled at the end retainers 21 respectively. Accordingly, the bracket assembly 20 further comprises a detachable fastener 22 formed at each of the end retainers 21 that the first and second ends 311, 321 of the first and second guiding shafts 31, 32 are detachably coupled with the detachable fasteners 22 at the end retainers 21 respectively. As shown in FIGS. 2 and 3, each of the detachable fasteners 22 is configured to have an enlarged head extended from the corresponding end retainer 21, wherein each of the connecting bodies 313, 323 is configured to have a loop portion, such that the loop portions of the connecting bodies 313, 323 are detachably coupled with the enlarged heads of the detachable fasteners 22 respectively.

It is worth mentioning that the space expansion unit is replaceable between the end retainers 21 to selectively adjust the expansion force of the resilient element 40. For example, a stronger resilient element 40 having a larger expansion force can be initially coupled between the end retainers 21 to gradually move the abutting teeth 12 away from each other. After a predetermined of treatment time, a weaker resilient element 40 having a weaker expansion force can be coupled between the end retainers 21 to continuously move the abutting teeth 12 away from each other. In addition, if one of the resilient element 40 and the space guider 30 is damaged or misaligned, the damaged space expansion unit can be replaced by a new one. In other words, the space expansion unit can provide different strength of expansion force to meet the requirement of the orthodontics purpose.

According to the preferred embodiment, the bracket assembly 20 further comprises an adjustment retainer 23 adapted for affixing to the associated tooth 11, and a wiring element 24 extended between the end retainers 21 through the adjustment retainer 23. Therefore, when the end retainers 21 are moved away from each other in response to the expansion force, the adjustment retainer 23 is pulled to align between the end retainers 21 via the wiring element 24 for moving and aligning the abutting teeth 12 and the associated tooth 11 at the same time. Preferably, the structure of the end retainer 21 is identical to the structure of the adjustment retainer 23, except the detachable fastener 22 formed at the end retainer 21, wherein each of the end retainers 21 and the adjustment retainer 23 has a transverse affixing slot to enable the wiring element 40 to pass through and affix thereto.

Accordingly, the associated tooth 11 is positioned between the abutting teeth 12, such that the adjustment retainer 23 is located between the end retainers 21. Since the associated tooth 11 is misaligned with the abutting teeth 12, the wiring element 24 must be slightly bent in a curved configuration in order to enable the wiring element 24 to pass through the adjustment retainer 23 between the end retainers 21.

It is worth mentioning that the wiring element 24 is affixed to the end retainers 21 and the adjustment retainer 23, such that an operational length of the wiring element 24 between the end retainers 21 is fixed. As a result, when the end retainers 21 are moved away from each other via the expansion force of the resilient element 40, the curved form of the wiring element 40 will be straightened, so as to pull the associated tooth 11 to align with the abutting teeth 12.

In other words, the corrective space is enlarged by the opposite movement of the abutting teeth 12 and the associated tooth 11 is moved toward the corrective space at the same time. Therefore, the abutting teeth 12 and the associated tooth 11 are correspondingly moved by the same expansion force to ensure the corrective space to precisely fit the associated tooth 11 therewithin. In addition, the concurrent movements of the abutting teeth 12 and the associated tooth 11 will substantially reduce the treatment time for orthodontic.

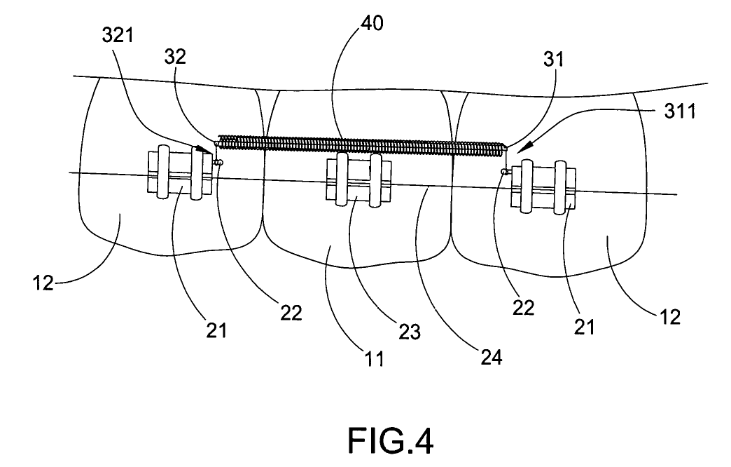

As shown in FIG. 4, the corrective space is enlarged when the end retainers 21 are moved away from each other by the expansion force to pull the abutting teeth 12 at the opposite directions. At the same time, the wiring element 40 is straightened by the expansion force to pull the associated tooth to the corrective space and to align the associated tooth with the abutting teeth 12, so as to reset the position of the associated tooth 11 between two abutting tooth 12 to a desired configuration in the patient's mouth.

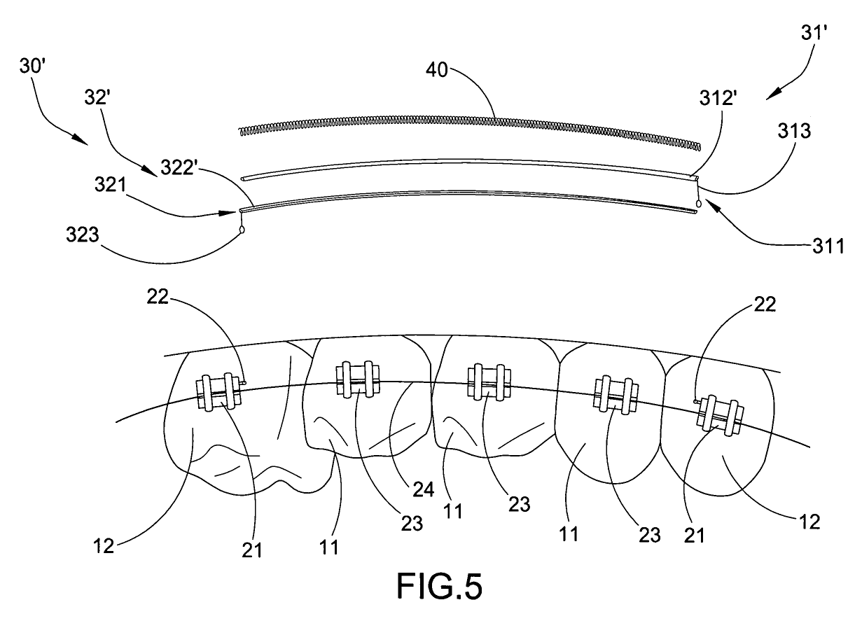

FIG. 5 illustrates two or more associated teeth 11 being moved to align with the abutting teeth 12 at the same time via the teeth adjustment arrangement. Accordingly, three associated teeth 11 are located between two abutting teeth 12 as an example in FIG. 5. Two end retainers 21 are affixed to the abutting teeth 12 respectively while three adjustment retainers 23 are affixed to the associated teeth 11 respectively. The wiring element 40 is affixed to the end retainers 21 and the adjustment retainers 23.

The space expansion unit is coupled between the end retainers 21 to create the expansion force against the end retainers 21 for enlarging the corrective space between the abutting teeth 12 to fit the associated teeth 11 therebetween. Due to the arch configuration of the teeth, i.e. the arc-shaped alignment of the associated teeth 11 and the abutting teeth 12, the space guider 30′ is configured to have an arc-shape corresponding to the arch configuration of the teeth. Therefore, the space guider 30′ not only guides the direction of the expansion force to ensure the direction of the expansion force exerting to the abutting teeth 12 but also retain the resilient element 40 between the end retainers 21.

In particular, the shaft bodies 312′, 322′ are two curved members to match with the arch configuration of the teeth, wherein the connecting bodies 313, 323 are transversely extended from the ends of the shaft bodies 312′, 322′ respectively. Therefore, when the first and second ends 311, 321 of the first and second guiding shaft 31′, 32′ are detachably coupled at the end retainers 21, the arc-shaped space guider 30′ matches with the arch configuration of the teeth, i.e. between the abutting teeth 12.

It is worth mentioning that a stronger resilient element 40 may be used to enlarge the corrective space for fitting two or more associated teeth 11. As a result, the three adjustment retainers 22 will be concurrently pulled at the same plane of the two end retainers 21, such that the three associated teeth 11 can be straightened to move on the same plane of the two abutting teeth 12.

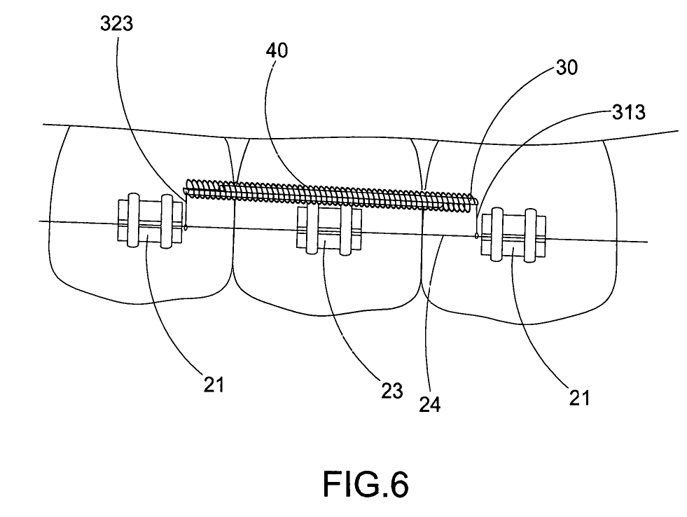

FIG. 6 illustrates an alternative mode of teeth adjustment arrangement which has the same configuration as mentioned above, except the detachable fastener 22. In other words, the end retainers 21 are identical to the adjustment retainer 23. In order to couple the space expansion unit is coupled between the end retainers 21, the wiring element 40 is affixed to the end retainers 21 through the loop portions of the connecting bodies 313, 323. In other words, the wiring element 40 slidably passes through the loop portion of the connecting body 313, 323 to affix to the corresponding end retainer 21. It should be appreciated that the space expansion unit of the present invention can be incorporated with the conventional tooth braces that the arch wire can pass through the loop portion of the connecting body 313, 323 to affix to the conventional bracket, so as to retain the space expansion unit between the abutting teeth 12.

It is worth mentioning that a position of the space expansion unit is preferably located close to the gum without contacting the gum, such that the gum will not be damaged by the space expansion unit, and the patient will feel more comfortable and less painful during the orthodontics process. Moreover, while the resilient element 40 is expanded, the gum will not be scratched by the space expansion unit.

The present invention further provides a method of resetting the position of the associated tooth 11 between two abutting tooth 12 to a desired configuration in the patient's mouth, wherein the method comprises the following steps.

(1) Affix the end retainers 21 to the abutting teeth 12 respectively.

(2) Couple the space expansion unit between the end retainers 21 to create the opposed expansion force against the end retainers 21. The step (2) further comprises the following steps.

(2.1) Extend the space guider 30 between the end retainers 21 to guide the direction of the expansion force.

(2.2) Couple the resilient element 40 along the space guider 30 to generate the expansion force for pushing the abutting teeth 12 away from each other. It is worth mentioning that the resilient element 40 is compressed at an initial state to be coupled between the end retainers 21.

(3) Affix the adjustment retainer 23 to the associated tooth 11. When two or more associated teeth 11 are located between the abutting teeth 12, two or more adjustment retainers 23 are affixed to the associated teeth 11 respectively.

(4) Extend the wiring element 40 between the end retainers 21 through the adjustment retainer 23. Therefore, when the end retainers 21 are moved away from each other in response to the expansion force, the adjustment retainer 23 is pulled to align between the end retainers 21 via the wiring element 40 for moving and aligning the abutting teeth 12 and the associated tooth 11 at the same time.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A teeth adjustment arrangement, comprising:
a bracket assembly which comprises a plurality of end retainers adapted for affixing to abutting teeth respectively; and
a space expansion unit coupled between said end retainers to create an opposed expansion force against said end retainers for enlarging a corrective space between said abutting teeth corresponding to an associated tooth therebetween.

2. The teeth adjustment arrangement, as recited in claim 1, wherein said bracket assembly further comprises an adjustment retainer adapted for affixing to said associated tooth, and a wiring element extended between said end retainers through said adjustment retainer, in such a manner that when said end retainers are moved away from each other in response to said expansion force, said adjustment retainer is pulled to align between said end retainers via said wiring element for moving and aligning said abutting teeth and said associated tooth at the same time.

3. The teeth adjustment arrangement, as recited in claim 1, wherein said space expansion unit comprises a space guider extended between said end retainers to guide a direction of said expansion force, and a resilient element coupled along said space guider to generate said expansion force for pushing said abutting teeth away from each other.

4. The teeth adjustment arrangement, as recited in claim 2, wherein said space expansion unit comprises a space guider extended between said end retainers to guide a direction of said expansion force, and a resilient element coupled along said space guider to generate said expansion force for pushing said abutting teeth away from each other.

5. The teeth adjustment arrangement, as recited in claim 3, wherein said space guider comprises a first guiding shaft having a first end coupled at one of said abutting teeth, and a second guiding shaft having a second end coupled at another said abutting tooth, wherein said first and second guiding shafts are slidably engaged with each other to retain said resilient element between said first and second ends so as to selectively adjust a distance between said first and second ends of said first and second guiding shafts in response to said expansion force.

6. The teeth adjustment arrangement, as recited in claim 4, wherein said space guider comprises a first guiding shaft having a first end coupled at one of said abutting teeth, and a second guiding shaft having a second end coupled at another said abutting tooth, wherein said first and second guiding shafts are slidably engaged with each other to retain said resilient element between said first and second ends so as to selectively adjust a distance between said first and second ends of said first and second guiding shafts in response to said expansion force.

7. The teeth adjustment arrangement, as recited in claim 4, wherein said resilient element is a compression spring coaxially coupled along said space guider for generating an expansion spring force as said expansion force to push said end retainers away from each other.

8. The teeth adjustment arrangement, as recited in claim 6, wherein said resilient element is a compression spring coaxially coupled along said space guider for generating an expansion spring force as said expansion force to push said end retainers away from each other.

9. The teeth adjustment arrangement, as recited in claim 8, wherein each of said first and second guiding shafts has a semi-circular cross section, such that when said first and second guiding shafts are slidably engaged with each other to have a circular cross section, said first and second guiding shafts are coaxially received within said compression spring.

10. The teeth adjustment arrangement, as recited in claim 6, wherein said bracket assembly further comprises a detachable fastener formed at each of said end retainers that said first and second ends of said first and second guiding shafts are detachably coupled with said detachable fasteners at said end retainers respectively.

11. The teeth adjustment arrangement, as recited in claim 9, wherein said bracket assembly further comprises a detachable fastener formed at each of said end retainers that said first and second ends of said first and second guiding shafts are detachably coupled with said detachable fasteners at said end retainers respectively.

12. The teeth adjustment arrangement, as recited in claim 6, wherein each of said first and second ends of said first and second guiding shafts has a loop shape that said wiring element slidably passes through said first and second ends of said first and second guiding shafts to affix to said end retainers.

13. The teeth adjustment arrangement, as recited in claim 9, wherein each of said first and second ends of said first and second guiding shafts has a loop shape that said wiring element slidably passes through said first and second ends of said first and second guiding shafts to affix to said end retainers.

14. A method of resetting a position of an associated tooth between two abutting tooth to a desired configuration in a patient's mouth, comprising the steps of:
(a) affixing a plurality of end retainers to said abutting teeth respectively; and
(b) coupling a space expansion unit between said end retainers to create an opposed expansion force against said end retainers for enlarging a corrective space between said abutting teeth corresponding to said associated tooth therebetween.

15. The method, as recited in claim 14, further comprising the steps of:
(c) affixing an adjustment retainer to said associated tooth; and
(d) extending a wiring element between said end retainers through said adjustment retainer, wherein when said end retainers are moved away from each other in response to said expansion force, said adjustment retainer is pulled to align between said end retainers via said wiring element for moving and aligning said abutting teeth and said associated tooth at the same time.

16. The method, as recited in claim 14, wherein said space expansion unit comprises a space guider and a resilient element, wherein the step (b) further comprises the steps of:
(b.1) extending said space guider between said end retainers to guide a direction of said expansion force; and
(b.2) coupling said resilient element along said space guider to generate said expansion force for pushing said abutting teeth away from each other.

17. The method, as recited in claim 15, wherein said space expansion unit comprises a space guider and a resilient element, wherein the step (b) further comprises the steps of:
(b.1) extending said space guider between said end retainers to guide a direction of said expansion force; and
(b.2) coupling said resilient element along said space guider to generate said expansion force for pushing said abutting teeth away from each other.

18. The method, as recited in claim 16, wherein said space guider comprises a first guiding shaft and a second guiding shaft, wherein the step (b.1) further comprises the steps of:
(b.1.1) coupling a first end of said first guiding shaft at one of said abutting teeth;
(b.1.2) coupling a second end of said second guiding shaft at another said abutting tooth; and
(b.1.3) slidably engaging said first and second guiding shafts with each other to retain said resilient element between said first and second ends so as to selectively adjust a distance between said first and second ends of said first and second guiding shafts in response to said expansion force.

19. The method, as recited in claim 17, wherein said space guider comprises a first guiding shaft and a second guiding shaft, wherein the step (b.1) further comprises the steps of:
(b.1.1) coupling a first end of said first guiding shaft at one of said abutting teeth;
(b.1.2) coupling a second end of said second guiding shaft at another said abutting tooth; and
(b.1.3) slidably engaging said first and second guiding shafts with each other to retain said resilient element between said first and second ends so as to selectively adjust a distance between said first and second ends of said first and second guiding shafts in response to said expansion force.

20. The method, as recited in claim 17, wherein said resilient element is a compression spring being compressed between said end retainers.

21. The method, as recited in claim 19, wherein said resilient element is a compression spring being compressed between said end retainers.

22. The method, as recited in claim 19, wherein said first and second ends of said first and second guiding shafts are detachably coupled at said end retainers respectively.

23. The method, as recited in claim 21, wherein said first and second ends of said first and second guiding shafts are detachably coupled at said end retainers respectively.

24. The method, as recited in claim 19, wherein said wiring element slidably passes through said first and second ends of said first and second guiding shafts to affix to said end retainers.

25. The method, as recited in claim 21, wherein said wiring element slidably passes through said first and second ends of said first and second guiding shafts to affix to said end retainers.
